(19) United States
(12) Patent Application Publication
(10) Pub. No.: US 2007/0147946 A1
(43) Pub. Date: Jun. 28, 2007

(54) Surgical prep solution applicator

(75) Inventors: Claude E. Cybulski, Lake Elmo, MN (US); Robert A. Davis, Cottage Grove, MN (US); Mary E. Hynan, Arden Hills, MN (US); Mark V. Johnson, Afton, MN (US); Daniel R. McIntyre, St. Paul, MN (US); Steven W. Stoner, Hugo, MN (US)

Correspondence Address: 3M INNOVATIVE PROPERTIES COMPANY, PO BOX 33427, ST. PAUL, MN, 55133-3427, US

(73) Assignee: 3M Innovative Properties Cornpany

(21) Appl. No.: 11/318,173

(22) Filed: Dec. 23, 2005

(51) Int. Cl. B43K 5/14; B43K 5/00

(52) U.S. Cl. 401/133; 401/134; 401/205

(57) ABSTRACT

Systems for applying or dispensing fluids such as surgical prep solution are disclosed. The applicator includes a barrel portion, container, and/or cap. The barrel portion, container and/or cap comprises elements such that they can be movably located relative to each other prior to activation.

### BACKGROUND OF THE INVENTION

Antiseptic preparation of patients for surgery conventionally includes a 3-10 minute scrubbing of the affected area with a soap solution followed by the application of a water-soluble antiseptic paint solution. Over the years, devices have been developed in an attempt to control solution delivery, and to reduce the time required for application of antiseptic solutions. In particular, the Duraprep™ products commercially available from 3M Company of St. Paul, Minn. have enjoyed commercial success by providing controlled, convenient application.

Coassigned U.S. Pat. No. 5,658,084 discloses a liquid applicator where the liquid is contained in a frangible ampoule inside the body of the applicator. The applicator is actuated by pushing at least a portion of the frangible ampoule through an aperture in the deformable element and into contact with a means for breaking the ampoule.

Prior to actuation, an applicator is typically provided with features in a locked or mated position in an attempt to prevent premature actuation during assembly, storage, and handling. The features of the applicator that prevent actuation require precision tolerances within a narrow range during manufacture and assembly. Applicators known in the art, such as those described in U.S. Pat. Nos. 5,769,552 and 6,505,985 with locked or mated positions to prevent activation, require tight tolerances to mate the opposing surfaces.

Thus, applicators that provide both ease of manufacture and prevent premature activation are needed.

### SUMMARY OF THE INVENTION

The present invention provides an applicator useful as an applicator for the application of fluids to a surface, comprising a hollow elongate member comprising a barrel portion and a dispensing portion; and a cap, comprising an annular side wall with an interior and exterior side, and an end wall, wherein the interior side comprises an internally projecting lip; wherein the barrel portion comprises an externally projecting ridge, a stopping element; and wherein the cap is positioned on the barrel portion such that the internally projecting lip is movably located between the externally projecting ridge and the stopping element.

In another embodiment an applicator for dispensing a fluid is provided, comprising a hollow elongate member comprising a barrel portion and a dispensing portion; and a cap, comprising an annulur side wall with an interior and exterior side, and an end wall, wherein the interior side comprises an internally projecting lip having a cross-sectional width; and wherein the barrel portion comprises an externally projecting ridge and a stopping element; and a preactivation length defined by the externally projecting ridge and the stopping element; wherein the preactivation length of the barrel portion is at least 10 mils greater the cross-sectional width of the internally projecting lip.

In another embodiment, an applicator for dispensing a fluid is provided, comprising a hollow elongate member comprising a barrel portion, wherein the barrel portion comprises an externally projecting ridge; a dispensing portion; a cap, comprising an annulur side wall with an interior and exterior side, and an end wall, wherein the interior side comprises an internally projecting lip; and a stopping element; wherein the stopping element is positioned on the cap, the barrel portion, or both such that the cap is movably located on the barrel portion.

In another embodiment, an applicator for dispensing a fluid is provided, comprising a hollow elongate member comprising a barrel portion, wherein the barrel portion comprises an internally projecting lip; a dispensing portion; a cap, comprising an annulur side wall with an interior and exterior side, and an end wall, wherein the exterior side comprises an externally projecting ridge; and a stopping element; wherein the stopping element is positioned on the cap, the barrel portion, or both such that the cap is movably located within the barrel portion.

In another embodiment, an applicator for dispensing a fluid is provided, comprising a hollow elongate member comprising a barrel portion, wherein the barrel portion comprises an internally projecting lip; a dispensing portion; a container within the hollow elongate member and comprising an externally projecting ridge; and a stopping element; wherein the stopping element is positioned on the container, the barrel portion, or both such that the cap is movably located within the barrel portion.

In another embodiment an applicator for dispensing a fluid is provided, comprising a hollow elongate member comprising a barrel portion, a dispensing portion, a container and optionally a cap; an externally projecting ridge; an internally projecting lip; and a stopping element; wherein a preactivation area is defined by the stopping element and at least one of the externally projecting ridge and internally projecting lip; wherein at least one of the externally projecting ridge and internally projecting lip not defining the preactivation area is located within the preactivation area; and wherein the preactivation area is located on the barrel portion, container, or cap such that the container or the cap is movably located relative to the barrel portion.

### BRIEF DESCRIPTION OF THE DRAWINGS

FIG. 1a is a cross-section side view of an illustrative embodiment of a surgical prep applicator;

FIG. 1b is a cross-section side view of an alternate illustrative embodiment of a surgical prep applicator;

FIG. 2 is an illustrative embodiment of an applicator known in the art;

FIG. 3 is a cross section side view of one illustrative embodiment of a cap and barrel portion of an applicator;

FIG. 4 is a partial cross section side view of one illustrative embodiment of a cap and barrel portion of an applicator;

FIG. 5 is a partial cross section side view of one illustrative embodiment of a cap and barrel portion of an applicator;

FIG. 6 is a partial cross section side view of one illustrative embodiment of a cap and barrel portion of an applicator;

FIG. 7a is a partial cross section side view of one illustrative embodiment of a cap and barrel portion of an applicator;

FIG. 7b is a partial cross section side view of one illustrative embodiment of a cap and barrel portion of an applicator.

### DETAILED DESCRIPTION

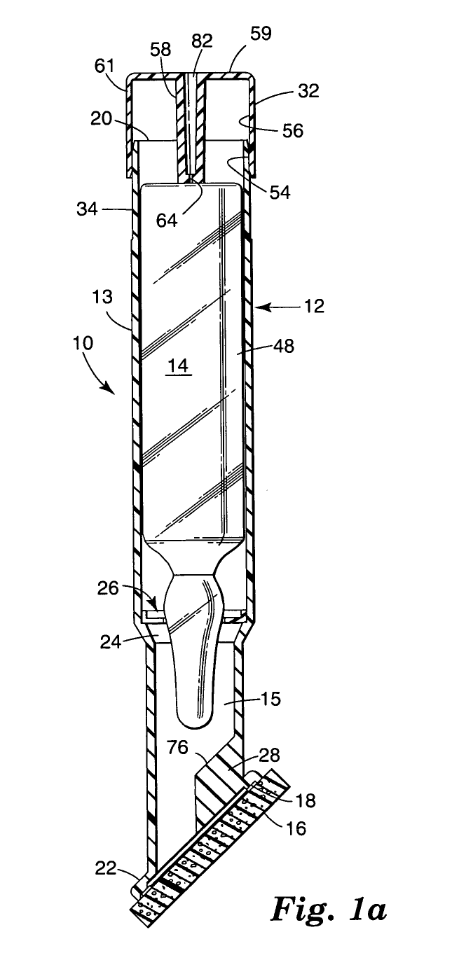

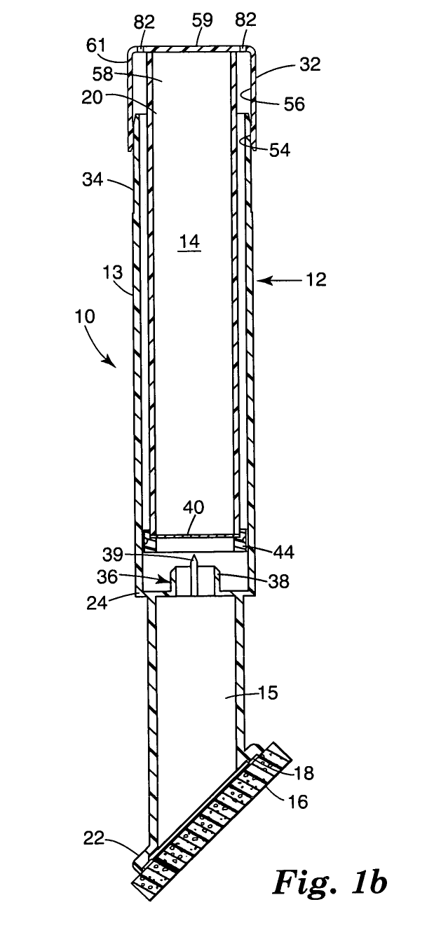

FIGS. 1-7 are illustrative embodiments of a fluid applicator that includes many aspects of a surgical prep applicator. It should, however, be understood that all of the features depicted in FIGS. 1-7 need not necessarily be present in all applicators according to the present invention. In other words, the features of the applicator depicted in FIGS. 1-7 may be used in concert or various combinations of the features may be employed in an applicator of the present invention.

The embodiments of the present invention provide a means to reliably deliver in a short period of time a surgical prep solution to the applicator sponge and uniformly distribute the prep solution throughout the applicator sponge. The applicator controls the flow rate of fluid to the applicator sponge and fluid distribution within the sponge without the need for external operator manipulation such as squeezing the liquid container or compressing the applicator sponge against an external surface. Although intended to apply modern, low viscosity, non-water-soluble, film-forming prep solutions, this device can be configured to apply a variety of solution compositions, viscosities, densities and volumes without compromising the fast wetting and uniform distribution features.

Referring to FIG. 1a, an illustrative embodiment of an applicator 10 comprises the following components: a container 14 comprising a frangible ampoule containing the solution to be dispensed; a hollow elongate member 12 adapted to accept the container 14, and having a flange 22 surrounding a first orifice 18; a cap 32 positioned over the second major orifice 20 of the hollow elongate member 12; and an absorbent pad 16 disposed over the flange 22. An example of a hollow elongate member with a frangible ampoule for delivering surgical prep solution is further described and shown in FIGS. 1 to 6 of U.S. Pat. No. 5,658,084, which is incorporated herein by reference. Other suitable configurations for the applicator include those described in U.S. Pat. Nos. 5,288,159 and 5,435,660, which are incorporated herein by reference.

The hollow elongate member 12 can be molded from any thermoplastic material compatible with the liquid to be dispensed. Preferably, the hollow elongate member 12 is molded from high density polyethylene. Features of the preferred embodiment of this component include a barrel portion 13, a dispensing portion 15, a first major orifice 18 with an integrally formed radially-projecting surrounding flange 22, a second major orifice 20 adapted to retain a cap 32.

The hollow elongate member 12 acts as a handle and as a fluid container after the container has been opened (i.e, when the ampoule has been broken), but before the solution is dispensed by the absorbent pad 16. The hollow elongate member 12 is bounded by a first major orifice 18 and second major orifice 20, one at each end. A flange 22 adapted to accept the absorbent pad 16 surrounds the first orifice 18. In a preferred embodiment, the hollow elongate member 12 is conveniently constructed to include a shoulder 24 disposed between the first orifice 18 and second orifice 20 adapted to support a collar 26 which serves as a deformable means for supporting and protecting the ampoule until the applicator 10 is to be used.

Alternate embodiments to a frangible ampoule for delivering the surgical prep solution include a pierceable container as shown in FIG. 1b. Container 14 includes a container seal 40 to prevent leakage of the liquid from the container 14 before activation. The container seal 40 may be, e.g., an adhesive or heat bonded foil laminate seal or other suitable construction that prevents unwanted leakage of the liquid solution. It may be preferred that the seal 40 also provide an effective barrier to the penetration of ethylene oxide gas during sterilization.

A piercing element 36 in the form of an annular die 38 with a puncturing projection 39 is provided at a shoulder 24 disposed between the first orifice 18 and second orifice 20. The piercing element 36 may be provided to, e.g., open a seal on the container such as the container seal 40, thereby allowing the liquid solution to move into the dispensing portion 15 and to the pad 16. As a result, when cap 32 is actuated by force, the piercing element 36 opens the container seal 40.

As shown in FIG. 1b, container 14 is maintained away from the piercing element 36 to prevent premature activation by integral attachment to cap 32. The container 14 can be integrally attached to cap 32 by attachment means known in the art, including but not limited to integrally molding, ultrasonic welds, hot plate welds, and mechanically fastened and/or adhesively fastened, or combinations thereof.

Container 14 may also be maintained away from piercing element 36 by means of a deformable structure (not shown) located at the junction of dispensing means 15 and handle portion 13. For example, hollow elongate member 12 can be constructed to include a deformable collar or fingers which serves as a deformable means for supporting and protecting the sealed container 14 until the applicator 10 is to be used.

Container 14 also optionally includes retainer ring 44 that retains the container seal 40 to container 14. The retainer ring 44 may provide added assurance that the container seal 40 remains intact and retains fluid within the container 14 prior to use of applicator 10.

While the illustrated embodiment is shown with an annular die 38 and a puncturing projection 39 as a piercing element 36, other arrangements known in the art which pierce the seal may be used, which may be centered or off-center within hollow elongate member 12. Further, the piercing element (in whatever form) may be formed as an integral part of the hollow elongate member 12, or it may be provided as a separate insert assembled into the hollow elongate member 12.

Referring to FIGS. 1a and 1b, the container 14 should form a barrier to materials and methods used in sterilization such as ethylene oxide gas, irradiation methods, and hydrogen peroxide. Suitable barrier materials for the container 14 include glass and high density polyethylene.

For surgical prep applications, it is important that the hollow elongate member 12 be long enough to prevent contact of the patient by the person applying the surgical prep solution. Preferably, for such applications the hollow elongate member is at least 10 cm in length. In the preferred embodiment, the tubular handle portion 13 of the hollow elongate member has a larger diameter than the dispensing portion 15.

The hollow elongate member is any molded plastic piece about 10-20 cm, preferably about 15 cm in length having an attachment means for the pad at the base. Preferably, the hollow elongate member 12 and flange 22 are integrally formed, such as by injection molding processes. The base portion of the hollow elongate member is preferably at an angle of 45 degrees to the axis of the hollow elongate member.

Integrally-formed flange 22 surrounds the first orifice 18 and is angled from the longitudinal axis of the hollow elongate member 12 by between 30 and 90 degrees in most embodiments. Most preferably, there is about a 45 degree angle between the flange 22 and the longitudinal axis of the hollow elongate member 12.

Absorbent pad 16 preferably, but not necessarily, is larger than the base of hollow elongate member 12. This arrangement allows for soft edges and also facilitates prepping between digits of the human hand or other narrow prepping surfaces. Absorbent pad 16 may be of any shape that makes fluid application convenient. Shapes such as rectangles, ellipses, circles, triangles, ovals, etc., are contemplated.

The absorbent pad 16 can be selected from a variety of commercially available materials having a wide range of compression set ratios, densities and porosities. For a given volume, viscosity, density and surface tension of the liquid, wetting of the absorbent pad can be accomplished by appropriate specification of the average pore size, pore size distribution, void volume fraction and surface energy of the material from which the absorbent pad 16 is formed, and the permanent compression set ratio and porosity of the open-cell absorbent pad 16. The compression state (i.e., compressed or uncompressed) and porosity of the foam sponge are adjusted in relation to the viscosity, density, volume and surface tension of the liquid to be dispensed to allow a portion of the liquid contained in the applicator to flow to the outer surface of the foam sponge.

The absorbent pad 16 comprises a foam material compatible with the liquid to be dispensed. Suitable foam sponge materials are prepared from thermoplastic materials such as polyethylene and polyurethane. Especially preferred opencell foam materials are prepared from polyurethane thermoplastics. The foam material can be reticulated (open cell) or non-reticulated (closed cell) foam. The foam material can also be compressed (felted) or uncompressed. Preferably, the foam material is reticulated and uncompressed.

Many other materials for the absorbent pad may be possible, including non-woven carded webs, filter material, knit pads, such as gauze, woven pads, and the like. These pads can be made from synthetic or natural polymers. It is also contemplated in the present invention that an additional layer of a fabric may be placed over the absorbent pad. Such additional fabrics may aid in coating uniformity.

The selection of the foam material will also affect wicking and reservoiring properties of the foam sponge. The foam material can also affect the coating characteristics of the applicator. Preferably, for surgical prep applications, the porosity of the foam sponge material is between 4 and 40 pores per linear centimeter, more preferably about 35 pores per linear centimeter. A particularly preferred open-cell foam sponge material is an elastomeric polyurethane foam having a porosity of about 35 pores per linear centimeter, commercially available from Foamex, LP, East Providence, R.I. as “Z90CLB”.

The absorbent pad 16 is attached to the flange 22 by a seal formed between the absorbent pad and the flange 22. The seal between the absorbent pad and flange 22 may be formed by any suitable bonding techniques known in the art such as adhesives, hot plate welding, solvent bonding, ultrasonic welding, inductive welding, and plastic rod welding. In a preferred embodiment, the absorbent pad is attached to the projecting element to form a seal by hot plate welding.

The distribution and rate of delivery of the liquid to the absorbent pad 16 can also be controlled by a distributor element as described in U.S. application Ser. No. 10/958,444, filed Oct. 4, 2004, which is incorporated by reference herein. A metering film may also be used in the applicator of the present invention. One example of a suitable metering film having a porous structure, preferably a replicated patterned structure, is described in U.S. Pat. No. 5,658,084. One type of useful flexible porous layer is a microstructured isoporous membrane having an array of pores therein, described in commonly assigned U.S. Pat. No. 5,308,180.

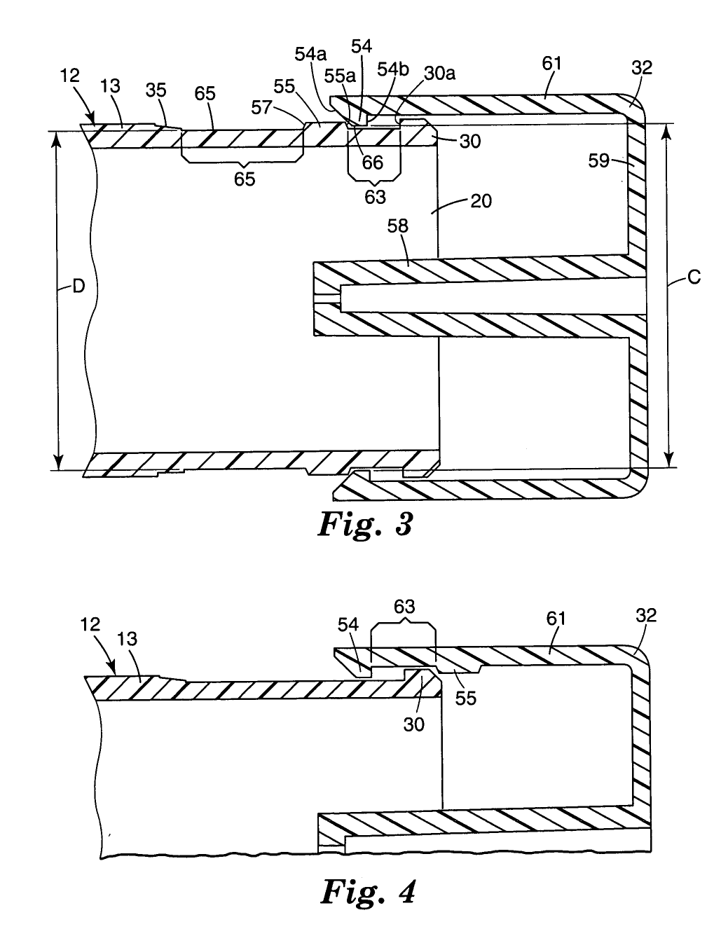

As shown in FIGS. 1a and 1b, a cap 32 covers the second major orifice 20 of the barrel portion 13 of hollow elongate member 12. The cap includes an end wall 59 and annular side walls 61. The cap 32 can be fabricated from any compatible thermoplastic material. In the preferred embodiment, the cap element is injection molded from high density polyethylene. The cap is adapted to be attached to barrel portion 13 by means of a snap fit. This is accomplished by providing lip 54 inwardly projecting from side walls 61 adjacent to the major orifice 56 of the cap 32 which has a smaller inside diameter than the outside diameter of the outwardly projecting ridge 30 (as shown in FIG. 3) adjacent to the second orifice 20 of the barrel portion 13. When the applicator 10 is assembled, the lip 54 of cap 32 is snapped over the outwardly projecting ridge 30 on the barrel portion 13.

The cap 32 is adapted to transmit an actuation force to the container 14 through end wall 59 as the cap is axially displaced in the direction towards absorbent pad 16. In FIG. 1a, the actuation force is transmitted by column 58 which axially projects from the interior surface of the end wall 59 of cap 32. Axial movement of column 58 in the direction towards absorbent pad 16 forces the entire neck of container 14 through the aperture in collar 26 and causes the neck to contact the wedge 28, breaking the container 14.

In FIG. 1b, the actuation force is directly transmitted by the cap 32 displacing the integrally attached walls of container 14 towards absorbent pad 16. Axial movement of container 14 in the direction towards absorbent pad 16 forces the container seal 40 onto piercing element 36 and causes the container seal 40 to rupture.

In order to avoid creating a vacuum and restricting flow through the applicator, a means of maintaining atmospheric pressure in the device is preferably employed. One or more holes in the cap 32 functions to aspirate air into the internal volume of the applicator as the liquid flows into the absorbent pad 16 to maintain atmospheric pressure within the device and prevent “air locking.” Thus, in the embodiment illustrated in FIG. 1a, column 58 is constructed with an axial hole with a first larger orifice 82 that communicates to the external surface of the cap, and a vent 64 at the end of the column 58. In an alternate less preferred embodiment illustrated in FIG. 1b, one or more holes 82 (and/or channels not shown) are provided in the end wall 59 of the cap 32.

Preferably, the geometry and location of the air vent would not result in leakage of liquid from the device. In FIG. 1a, the annular volume between the end wall 59 and axial column 58 of the cap 32 and the inside surface of the hollow elongate member 12 adjacent to the second orifice 20 provides a reservoir for liquid when the applicator 10 is inverted. The height of column 58 is designed to exceed the level of liquid in the annular volume thereby preventing liquid from leaking out of the air vent 64 of the column 58.

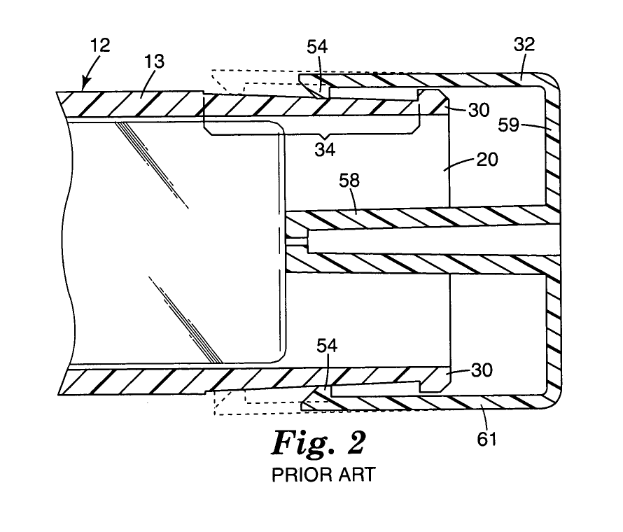

In FIG. 2, a cap as provided in U.S. Pat. No. 5,288,159 is adapted to provide a liquid seal between the cap 32 and the hollow elongate member 12. This is accomplished by providing that the inside diameter of the inwardly projecting lip 54 on the cap 32 is smaller than the outside diameter of hollow elongate member 12 at sealing surface 34 thereby providing an axially slidable seal by means of an interference fit. To avoid premature activation, the inwardly projecting lip 54 is positioned during assembly at a desired location.

When manufacturing two components that register closely to each other and which are intended to translate from one position to another, precision tolerances are required in one or more of the following parameters: in the location (of both components relative to a fixed reference); proximity between the two components as determined by the relative size of the two components; and shape (geometric design) of the mating components. Individually or collectively, these parameters describe the fit between two components. The interference fit of FIG. 2 that provides the axially slidable seal requires precision tolerances (i.e., +/−2 mils or less) during manufacture of the barrel and cap during both molding of the barrel and assembly of the cap on the barrel. Tolerances used in manufacturing are known in the art to fall within commercial tolerances (+/−8.5 mils) and fine tolerance (+/−7 mils) as discussed in Society of Plastics Industry, Standards and Practices of Plastics Molders (1998 Ed.). In medical device manufacture, the tolerances typically are block tolerances (+/−5 mils) and precision tolerances (+/−2 mils).

In contrast, the components of the present invention as more fully described below do not require precision tolerances while still maintaining the reliability and functionality of the applicator 10. In FIG. 3, an illustrative embodiment of a cap 32 and barrel portion 13 of the present invention is provided. The barrel portion 13 further comprises a stopping element 55. When the applicator 10 is assembled, lip 54 of cap 32 is snapped over the outwardly projecting ridge 30 on the hollow elongate member 12. The area on the barrel portion 13 defined by the ridge 30 and stopping element 55 creates a preactivation area 63. The lip 54 is positioned between the ridge 30 and stopping element 55 such that the lip 54 is movably located in the preactivation area 63.

As used herein, movably located generally means that two or more components can move freely relative to one another without being in a locked or mated position. Thus, internally projecting lip 54 of cap 32 in FIG. 3 can be movably located within preactivation area 63 without contacting any part of the externally projecting ridge 30, stopping element 55, or the surface of barrel portion 13.

Preactivation area 63 has a length on the surface of the barrel portion 13 as measured from mutually facing sides 30a and 55a of externally projecting ridge 30 and stopping element 55 respectively. In a preferred embodiment, the length of preactivation area 63 is greater than the width of the face 66 of internally projecting lip 54, as measured between lip edges 54a and 54b, such that the cap 32 is movably located relative to barrel portion 13. The difference of the length of preactivation area 63 and the width of the face 66 of internally projecting lip 54 is preferably greater than 10 mils, even more preferably greater than 20 mils.

The area on the barrel portion 13 defined by the stopping element 55 and the sealed area 35 creates an activation area 65. After activation of the applicator, the lip 54 is positioned between the stopping element 55 and the sealed area 35 such that the lip 54 can be movably located in the activation area 65. When the cap 32 is movably located on barrel portion 13 in both the preactivation area 63 and activation area 65, the inner diameter of the cap 32 at internally projecting lip 54 (shown as C in FIG. 3) can be greater than or equal to outer diameter of the barrel portion 13 in preactivation area 63 and activation area 65 (shown as D in FIG. 3). Preferably, the inner diameter C is equal to D. More preferably, the inner diameter C is at least 2 mils greater than D. Thus, the cap 32 of the present invention does not require an interference fit in the preactivation area 63 or activation area 65 of barrel portion 13.

In an alternate embodiment shown in FIG. 4, stopping element 55 is positioned on the cap 32 on the interior side of annular side wall 61. The area on the cap 32 defined by the internally projecting lip 54 and stopping element 55 creates a preactivation area 63. Preactivation area 63 has a length on the interior of side wall 61 of cap 32 as measured from mutually facing sides of internally projecting lip 54 and stopping element 55 respectively. When the applicator 10 is assembled, lip 54 of cap 32 is snapped over the externally projecting ridge 30 on the barrel portion 13. The externally projecting ridge 30 is positioned between the internally projecting lip 54 and stopping element 55 such that the ridge 30 is movably located in the preactivation area 63.

To activate the applicator, a minimal force can be applied to cap 32 to move, in a direction parallel to the barrel portion 13, the internally projecting lip 54 over the stopping element 55 (as embodied in FIG. 3) or the stopping element 55 over the externally projecting ridge 30 (as embodied in FIG. 4). In an alternate embodiment (not shown), at least a portion of the cap wall can be deformed to raise the internally projecting ridge 30 above the height of the stopping element 55 and move the ridge 30 past the stopping element 55. After activation, the internally projecting lip 54 traverses activation area 65 to form a seal at the sealing area 35 on barrel portion 13.

Although preferred and shown as circumferentially continuous elements, the ridge 30, lip 54 and stopping element 55 can be discontinuous on barrel portion 13 and/or within cap 32. In a less preferred embodiment, for example, internally projecting lip 54 of cap 32 would not move over stopping element 55 but rather cap 32 would be rotated to appropriately align discontinuous portions of lip 54 with discontinous openings of stopping element 55 to allow axial movement of cap 32 to activate the applicator.

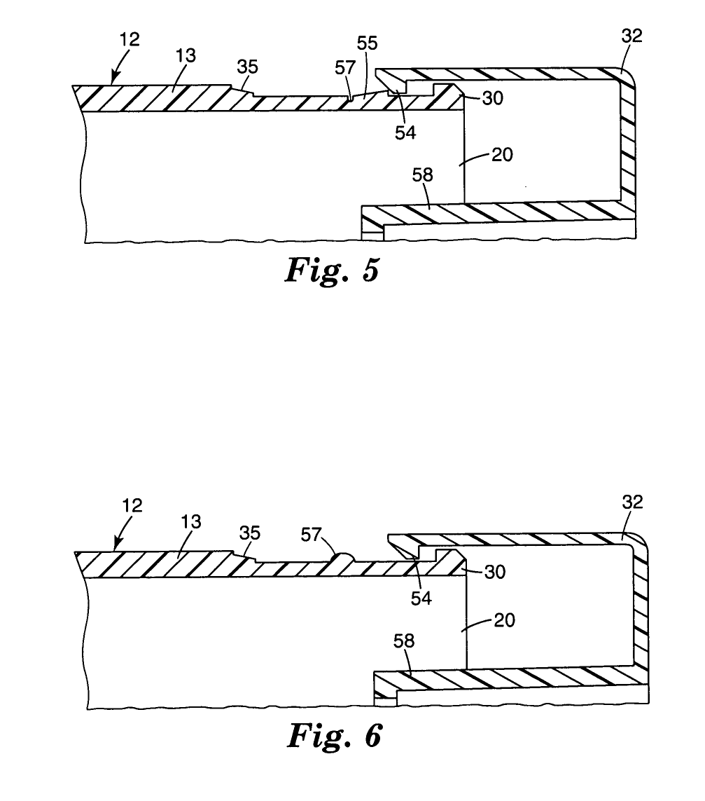

In a preferred embodiment shown in FIG. 3, the edge of stopping element 55 has a visual indication 57. The visual indication 57 serves to indicate to the user that the cap 32 is within the preactivation area 63. In another embodiment as shown in FIG. 5, cap 32 further comprises a visual indication 57 as an indentation on the surface of the barrel, i.e., a channel. In another embodiment shown in FIG. 6, the stopping element 55 is a raised area, i.e., a rib, on the surface of barrel portion 13 that also serves as visual indication 57. Other embodiments of the visual indication 57 include a series of raised areas on the surface or non-structural indications, i.e., ink markings, which may or may not be positioned on, or part of, stopping element 55.

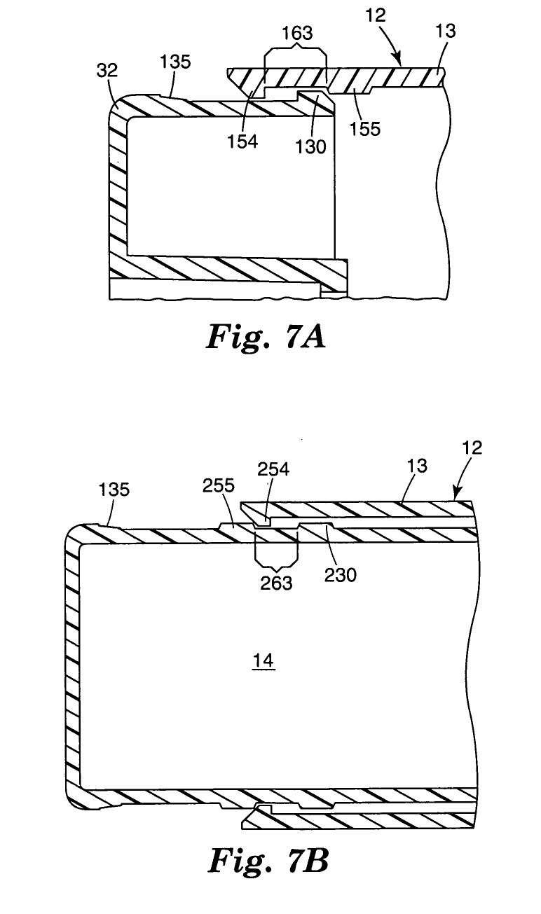

In FIG. 7A, an alternate illustrative embodiment of a cap 32 and barrel portion 13 of the present invention is provided. In this embodiment, the cap 32 is positioned internally relative to barrel portion 13 and comprises an externally projecting ridge 130. The barrel portion 13 comprises a internally projecting lip 154. When the applicator is assembled, lip 154 of barrel portion is snapped over the externally projecting ridge 130 on cap 32. The barrel portion 13 further comprises a stopping element 155. The area on the barrel portion 13 defined by the lip 154 and stopping element 155 creates a preactivation area 163. The ridge 130 is positioned between the lip and stopping element 155 such that the ridge 130 is movably located in the preactivation area 163. Thus, externally projecting ridge 130 of cap 32 in FIG. 7A can be movably located within preactivation area 163 without contacting any part of the internally projecting lip 154, stopping element 155, or the internal surface of barrel portion 13.

Preactivation area 163 has a length on the internal surface of the barrel portion 13 as measured from mutually facing sides of internally projecting lip 154 and stopping element 155 respectively. In a preferred embodiment, the length of preactivation area 163 is greater than the width of the face of externally projecting ridge 130 such that the cap 32 is movably located relative to barrel portion 13. The difference of the length of preactivation area 163 and the face width of externally projecting ridge 130 is preferably greater than 10 mils, even more preferably greater than 20 mils.

The cap 32 further comprises sealed area 135. After activation of the applicator, the cap 32 travels in the axial direction until the lip 154 contacts sealing area 135 to form a seal with barrel portion 13.

In an alternate embodiment shown in FIG. 7B, as an alternate variation of FIG. 1b, container 14 no longer requires integral attachment to a cap. Rather, container 14 comprises a stopping element 255 that can maintain the container 14 away from the piercing element (not shown). Container 14 comprises an externally projecting ridge 230 and stopping element 255. The barrel portion 13 comprises an internally projecting lip 254. When the applicator 10 is assembled, lip 254 of barrel portion 13 is snapped over the externally projecting ridge 230 of container 14. The internally projecting lip 254 is positioned between externally projecting ridge 230 and stopping element 255 such that the lip 254 is movably located in the preactivation area 263.

To activate the applicator, a minimal force can be applied to container 14 to move, in a direction parallel to the barrel portion 13, the stopping element 255 on container 14 moves over the internally projecting lip 254 on barrel portion 13. After activation, the internally projecting lip 254 travels in the axial direction until the lip 254 contacts sealing area 235 on container 14 to form a seal with barrel portion 13.

As noted above, the applicator is useful in dispensing antiseptic liquids to disinfect a surgical field prior to surgery. The applicator of this invention may be particularly useful in dispensing liquids having viscosities at room temperature of less than about 10,000 cps, most preferably less than about 500 cps. Examples of suitable antiseptic preparations include those described in U.S. Pat. No. 4,584,192 and those described in U.S. Pat. No. 4,542,012, the disclosures of which are incorporated herein by reference. Preferred antiseptic preparations are iodophoric skin tinctures, such as “Duraprep™ Surgical Solution,” commercially available from 3M.

The containers used in connection with the present invention may also be filled with a compositions that include (as the antimicrobial agent) iodine, an iodine complex, chlorhexidine, chlorhexidine salts, or combinations thereof. Preferred iodine complexes may include iodophors, e.g., povidone-iodine USP. Preferred chlorhexidine salts may include, e.g., chlorhexidine digluconate and chlorhexidine diacetate. Other suitable antimicrobial agents may include C2-C5 lower alkyl alcohols (including, e.g., ethyl alcohol, 1-propanol, and 2-propanol), parachlorometaxylenol (PCMX), triclosan, hexachlorophene, fatty acid monoesters of glycerin and propylene glycol such as glycerol monolaurate, glycerol monocaprylate, glycerol monocaprate, propylene glycol monolaurate, propylene glycol monocaprylate, propylene glycol moncaprate, phenols, surfactants, and polymers that include a (C12-C22)hydrophobe and a quaternary ammonium group, polyquaternary amines such as polyhexamethylene biguanide, quaternary ammonium silanes, silver, silver salts (such as silver chloride), silver oxide and silver sulfadiazine, methyl, ethyl, propyl and butyl parabens, octenidene, peroxides (e.g., hydrogen peroxide and benzoyl peroxide), and the like, as well as combinations thereof.

For use in preparation for a small surgical procedure, the amount of skin antiseptic composition in the containers used in connection with the present invention should generally be able to cover an area of, e.g., 10 square centimeters or more. For larger surgical procedures, the applicator should be able to cover at least the torso of a large person, e.g., at least about 500-600 square centimeters.

While the applicators described herein are contemplated for use with surgical prep solutions, other applications may also utilize the applicator of the present invention. Other fluids for use in the applicator include, but are not limited to cleaning agents, varnishes, stains and lacquers.

Illustrative embodiments of this invention are discussed and reference has been made to possible variations within the scope of this invention. These and other variations and modifications in the invention will be apparent to those skilled in the art without departing from the scope of this invention, and it should be understood that this invention is not limited to the illustrative embodiments set forth herein. Accordingly, the invention is to be limited only by the claims provided below.

Although specific embodiments of the invention have been described herein, it is not intended to limit the invention solely thereto, but to include all of the obvious variations and modifications within the spirit and scope of the appended claims.

Illustrative embodiments of this invention are discussed and reference has been made to possible variations within the scope of this invention. These and other variations and modifications in the invention will be apparent to those skilled in the art without departing from the scope of this invention, and it should be understood that this invention is not limited to the illustrative embodiments set forth herein. Accordingly, the invention is to be limited only by the claims provided below.

What is claimed is:

1. An applicator for dispensing a fluid, comprising:
a hollow elongate member comprising a barrel portion and a dispensing portion; and
a cap, comprising:
an annulur side wall with an interior and exterior side, and an end wall,
wherein the interior side comprises an internally projecting lip;
wherein the barrel portion comprises
an externally projecting ridge;
a stopping element; and
wherein the cap is positioned on the barrel portion such that the internally projecting lip is movably located between the externally projecting ridge and the stopping element.

2. The applicator of claim 1, further comprising a sealed area on the barrel portion that forms a seal when in contact with the internally projecting lip of the cap.

3. The applicator of claim 1, further comprising a container within the hollow elongate member.

4. The applicator of claim 3, wherein the container is integrally attached to the cap.

5. The applicator of claim 3, wherein the container is integrally molded to the cap.

6. The applicator of claim 1, wherein a minimal axial force is applied to the cap to move the internally projecting lip over the stopping element in a direction parallel to the barrel portion to activate the applicator.

7. The applicator of claim 1, wherein at least a portion of the internally projecting lip and the stopping element are discontinuous such that when the discontinuous portions are aligned, the internally projecting lip moves without deformation past the stopping element in a direction parallel to the barrel portion.

8. The applicator of claim 1, further comprising a visual indication that internally projecting lip is located in the preactivation area.

9. The applicator of claim 8, wherein the visual indication is selected from the group consisting of a channel; a rib; a series of raised areas; ink markings; and combinations thereof.

10. The applicator of claim 9, wherein the visual indication is located in or on the stopping element.

11. The applicator of claim 1, wherein the absorbent pad is uncompressed open-cell foam.

12. The applicator of claim 1, wherein the hollow elongate member holds surgical prep solution.

13. The applicator of claim 12, wherein the surgical prep solution is selected from the group consisting of iodine, and chlorhexidine and its salts.

14. The applicator of claim 3, wherein the container is substantially impermeable to ethylene oxide gas.

15. An applicator for dispensing a fluid, comprising:
a hollow elongate member comprising a barrel portion and a dispensing portion; and
a cap, comprising:
an annulur side wall with an interior and exterior side, and an end wall,
wherein the interior side comprises an internally projecting lip having a cross-sectional width; and
wherein the barrel portion comprises
an externally projecting ridge;
a stopping element; and
a preactivation length defined by the externally projecting ridge and the stopping element;
wherein the preactivation length of the barrel portion is at least 10 mils greater than the cross-sectional width of the internally projecting lip.

16. The applicator of claim 15, wherein the preactivation length of the barrel portion is at least 20 mils greater the cross-sectional width of the internally projecting lip.

17. The applicator of claim 15, wherein the inner diameter of the cap at the internally projecting lip is at least equal to outer diameter of the barrel portion at the preactivation length.

18. The applicator of claim 15, wherein the inner diameter of the cap at the internally projecting lip is at least 2 mils greater than outer diameter of the barrel portion at the preactivation length.

19. The applicator of claim 15, further comprising a sealed area on the barrel portion that forms a seal when in contact with the internally projecting lip of the cap.

20. The applicator of claim 15, further comprising a container within the hollow elongate member.

21. The applicator of claim 15, wherein the container is integrally attached to the cap.

22. The applicator of claim 15, wherein a minimal axial force is applied to the cap to move the internally projecting lip over the stopping element in a direction parallel to the barrel portion to activate the applicator.

23. The applicator of claim 15, wherein at least a portion of the internally projecting lip and the stopping element are discontinuous such that when the discontinuous portions are aligned, the internally projecting lip moves without deformation past the stopping element in a direction parallel to the barrel portion.

24. The applicator of claim 15, further comprising a visual indication of the location of the internally projecting lip in the preactivation area.

25. The applicator of claim 15, wherein the hollow elongate member holds surgical prep solution.

26. An applicator for dispensing a fluid, comprising:
a hollow elongate member comprising a barrel portion, wherein the barrel portion comprises an externally projecting ridge;
a dispensing portion;
a cap, comprising an annulur side wall with an interior and exterior side, and an end wall, wherein the interior side comprises an internally projecting lip;
and a stopping element;
wherein the stopping element is positioned on the cap, the barrel portion, or both such that the cap is movably located on the barrel portion.

27. An applicator for dispensing a fluid, comprising:
a hollow elongate member comprising a barrel portion, wherein the barrel portion comprises an internally projecting lip;
a dispensing portion;
a cap, comprising an annulur side wall with an interior and exterior side, and an end wall, wherein the exterior side comprises an externally projecting ridge;
and a stopping element;
wherein the stopping element is positioned on the cap, the barrel portion, or both such that the cap is movably located within the barrel portion.

28. An applicator for dispensing a fluid, comprising:
a hollow elongate member comprising a barrel portion, wherein the barrel portion comprises an internally projecting lip;
a dispensing portion;
a container within the hollow elongate member and comprising an externally projecting ridge;
and a stopping element;
wherein the stopping element is positioned on the container, the barrel portion, or both such that the cap is movably located within the barrel portion.

29. An applicator for dispensing a fluid, comprising:
a hollow elongate member comprising a barrel portion, a dispensing portion, a container and optionally a cap;
an externally projecting ridge;
an internally projecting lip; and
a stopping element;
wherein a preactivation area is defined by the stopping element and at least one of the externally projecting ridge and internally projecting lip;
wherein at at least one of the externally projecting ridge and internally projecting lip not defining the preactivation area is located within the preactivation area; and
wherein the preactivation area is located on the barrel portion, container, or cap such that the container or the cap is movably located relative to the barrel portion.
